(19) United States
(12) Patent Application Publication
(10) Pub. No.: US 2023/0358963 A1
(43) Pub. Date: Nov. 9, 2023

(54) FIBER COMBINER WITH A CAPILLARY

(71) Applicant: Lumentum Operations LLC, San Jose, CA (US)

(72) Inventors: Gongwen ZHU, San Jose, CA (US); Guan SUN, San Jose, CA (US); Xiang PENG, San Ramon, CA (US)

(21) Appl. No.: 17/817,762

(22) Filed: Aug. 5, 2022

Related U.S. Application Data
(60) Provisional application No. 63/364,241, filed on May 5, 2022.

(51) Int. Cl. G02B 6/28

(52) U.S. Cl. CPC G02B 6/2804

(57) ABSTRACT

A fiber combiner includes a capillary and a plurality of input fibers disposed within the capillary. A first portion of the capillary has a first non-zero slope profile along a first portion of an output end of the fiber combiner. A second portion of the capillary has a second non-zero slope profile along a second portion of the output end of the fiber combiner. The second non-zero slope profile is different than the first non-zero slope profile.

### CROSS-REFERENCE TO RELATED APPLICATION

This Patent Application claims priority to U.S. Patent Application No. 63/364,241, filed on May 5, 2022, and entitled “HIGH BRIGHTNESS COMBINERS FABRICATED WITH ETCHED CAPILLARY TUBES.” The disclosure of the prior Application is considered part of and is incorporated by reference into this Patent Application.

### TECHNICAL FIELD

The present disclosure relates generally to fiber combiners and to fiber combiners with capillaries.

### BACKGROUND

Fiber combiners are critical components of high-power fiber lasers. A fiber combiner combines light of input fibers to increase a total power of light emitted by a fiber laser.

### SUMMARY

In some implementations, a fiber combiner comprises: a capillary; and a plurality of input fibers, wherein: a first portion of the plurality of input fibers is disposed within a first portion of the capillary along a first portion of an output end of the fiber combiner; the first portion of the capillary has a zero slope profile along the first portion of the output end of the fiber combiner; a second portion of the plurality of input fibers is disposed within a second portion of the capillary along a second portion of the output end of the fiber combiner; the second portion of the capillary has a first non-zero slope profile along the second portion of the output end of the fiber combiner; a third portion of the plurality of input fibers is disposed within a third portion of the capillary along a third portion of the output end of the fiber combiner; the third portion of the capillary has a second non-zero slope profile along the third portion of the output end of the fiber combiner, wherein the second non-zero slope profile is different than the first non-zero slope profile; a fourth portion of the plurality of input fibers is present along a fourth portion of the output end of the fiber combiner; and no portion of the capillary is present along the fourth portion of the output end of the fiber combiner.

In some implementations, a fiber combiner comprises: a capillary; and a plurality of input fibers disposed within the capillary, wherein: a first portion of the capillary has a first non-zero slope profile along a first portion of an output end of the fiber combiner; and a second portion of the capillary has a second non-zero slope profile along a second portion of the output end of the fiber combiner, wherein the second non-zero slope profile is different than the first non-zero slope profile.

In some implementations, a method for forming a fiber combiner includes inserting, into a capillary, a plurality of input fibers; causing a first portion of the capillary to have a first non-zero slope profile; and causing a second portion of the capillary to have a second non-zero slope profile.

### BRIEF DESCRIPTION OF THE DRAWINGS

FIGS. 1A-1F are diagrams of an example implementation described herein. All, or portions, of FIGS. 1A-1F may not be drawn to scale.

FIGS. 2A-2I are diagrams of an example implementation of a process for forming a fiber combiner described herein. All, or portions, of FIGS. 2A-2I may not be drawn to scale.

FIGS. 3A-3B are diagrams of an example implementation associated with a portion of a capillary described herein. All, or portions, of FIGS. 3A-3B may not be drawn to scale.

FIG. 4 is a diagram of an example implementation associated with the process for forming the fiber combiner described herein. All, or portions, of FIG. 4 may not be drawn to scale.

FIG. 5 is a flowchart of an example process associated with forming a fiber combiner with a capillary.

### DETAILED DESCRIPTION

The following detailed description of example implementations refers to the accompanying drawings. The same reference numbers in different drawings may identify the same or similar elements.

Combiners are critical components of high-power fiber lasers. In many cases, combiners arrange input fibers in a bundle configuration, which is spliced to an output fiber. In some cases, the input fibers are arranged in a twisted bundle configuration, which limits a taper length of the twisted bundle configuration (e.g., to splice to the output fiber) and thereby reduces a brightness of light that transmits to the output fiber. Such a twisted bundle configuration typically requires complicated tooling as well.

In some cases, a combiner includes an unetched capillary that is configured to hold the bundle of input fibers. Because the capillary is not etched, light leaks from the input fibers to the capillary, which reduces a brightness of light that is transmitted to the output fiber. The thicker the capillary is, the lower the resulting brightness of the light. As an example, for a conventional combiner that includes an unetched, undoped fused silica capillary, a numerical aperture (NA) of light in an input fiber of the conventional combiner is NAᵢₙ; a taper ratio is TR (e.g., a ratio of an original outer diameter of the capillary to an outer diameter of a waist of the capillary formed by tapering the capillary); an outer diameter of a bundle of input fibers disposed within the capillary is d; and an outer diameter of the capillary is D. When light escapes from the bundle of input fibers to the capillary, brightness degradation is D/d−1. Moreover, an NA of the light in an output fiber of the conventional combiner (e.g., after tapering) is NAₒᵤₜ=NAᵢₙ×TR×D/d. Consequently, the thicker the capillary is, the higher the NAₒᵤₜ will be, and therefore the higher the brightness degradation.

Some implementations described herein provide a fiber combiner (e.g., a pump combiner or a pump-signal combiner) that improves a brightness of a combined light beam that emits from the fiber combiner. In some implementations, the fiber combiner includes a capillary and a plurality of input fibers disposed within the capillary. A portion of the capillary has a first non-zero slope profile along a portion of an output end of the fiber combiner, and, in some implementations, another portion of the capillary has a second non-zero slope profile (e.g., that is different than the first non-zero slope profile) along another portion of the output end of the fiber combiner. In some implementations, an additional portion of the input fibers is present along an additional portion of the output end of the fiber combiner, but no portion of the capillary is present (e.g., because the portion of the capillary was removed, such as due to etching of the capillary).

In some implementations, the first non-zero slope profile and/or the second non-zero slope profile are adiabatic slope profiles, so leakage of the combined light beam as it propagates through corresponding portions of the capillary is minimized. Further, the plurality of input fibers may be arranged in a “straight” arrangement, not a “twisted” or “winding” arrangement, along the output end of the fiber combiner (e.g., because the capillary holds the plurality of input fibers in the straight arrangement). This enables a longer taper length of the plurality of input fibers, which increases a brightness of the combined light beam that emits from the output fiber. This also simplifies formation of the fiber combiner (e.g., because twisting and/or winding of the plurality of input fibers does not need to be performed).

Additionally, a portion of the capillary is removed from the output end of the fiber combiner, thereby a section of the output end of the fiber combiner with only the plurality of input fibers remains. This further minimizes leakage of the combined light beam as it propagates through the section of the output end of the fiber combiner (e.g., because brightness degradation through the capillary is reduced to zero). Accordingly, an NA of the combined light beam as it emits from the fiber combiner is minimized, and therefore the combined light beam has a higher brightness than a brightness of a combined light beam that would otherwise be emitted by a conventional combiner.

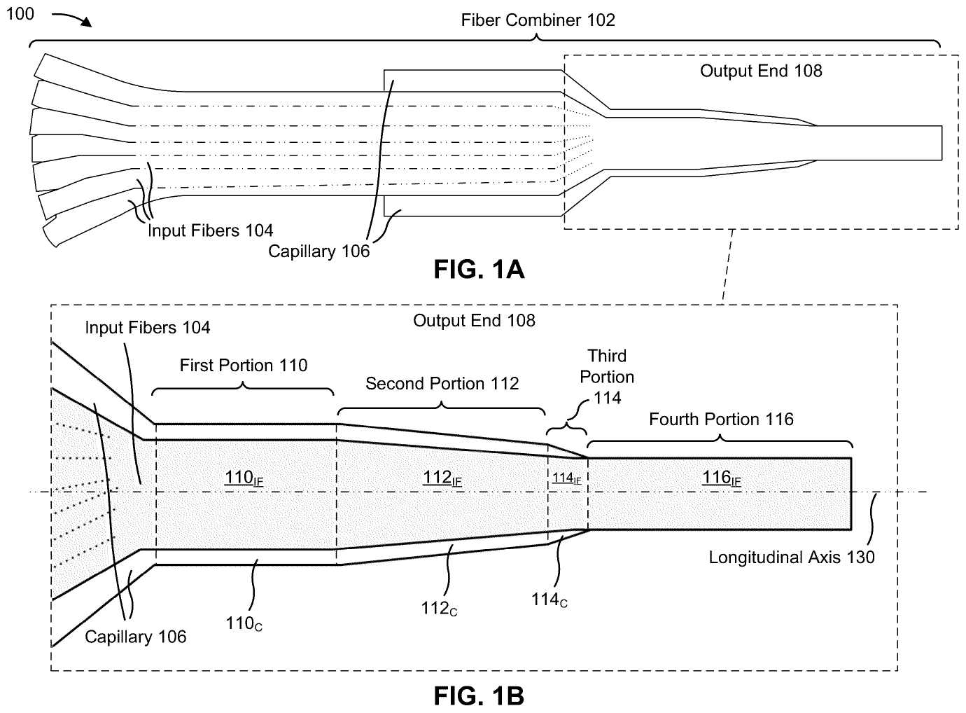

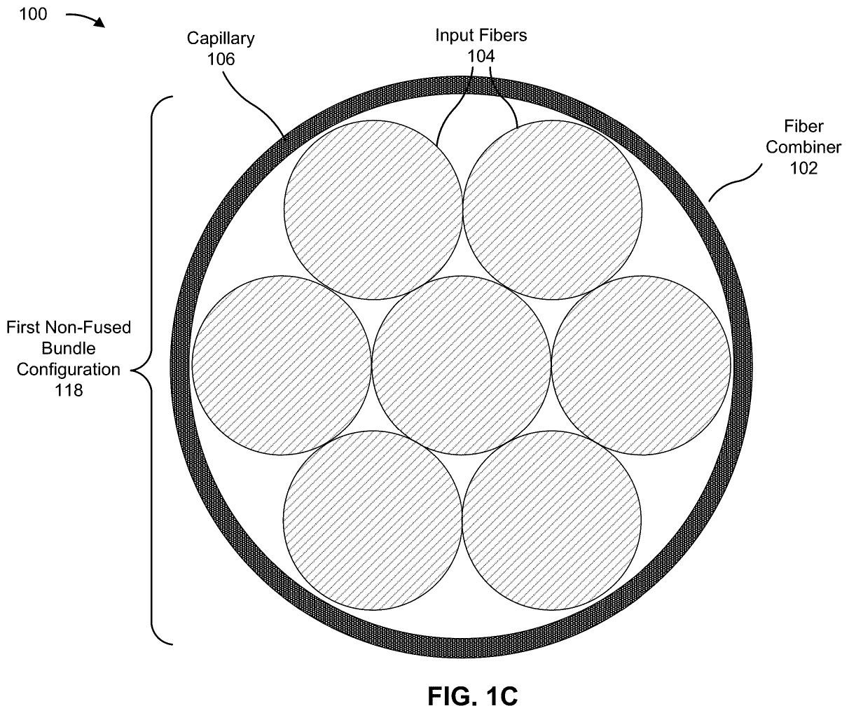

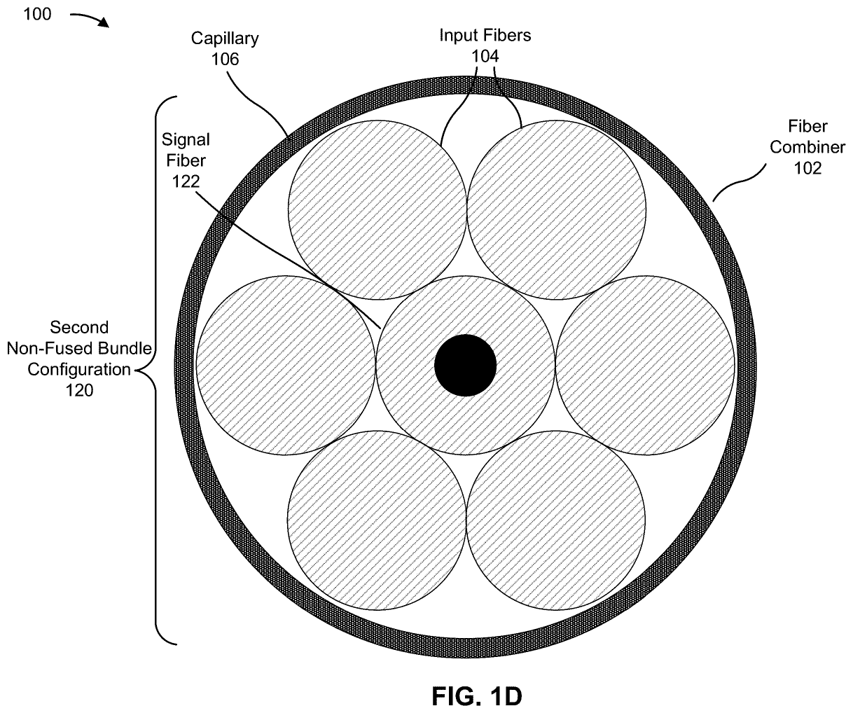

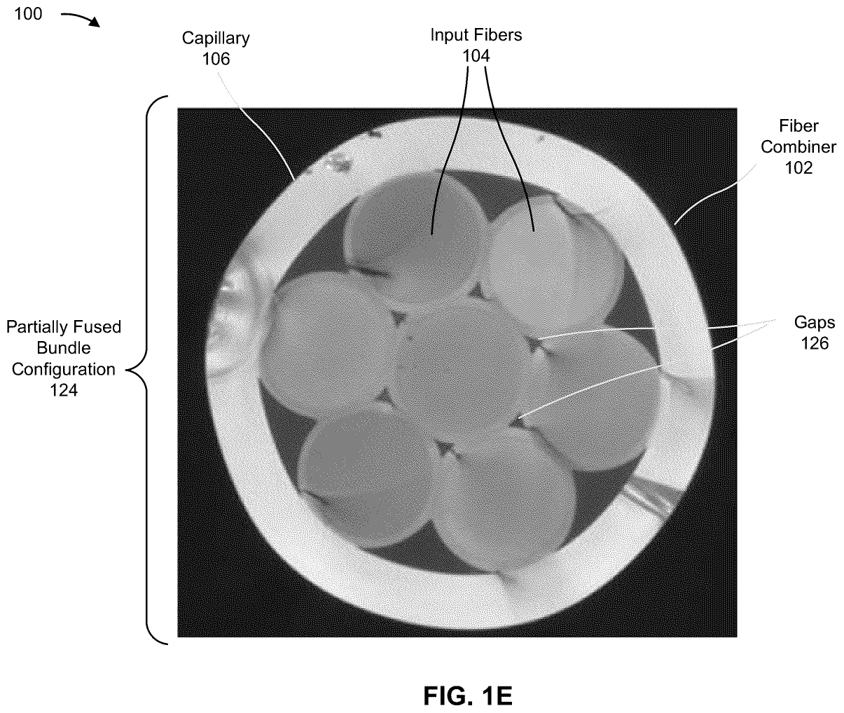

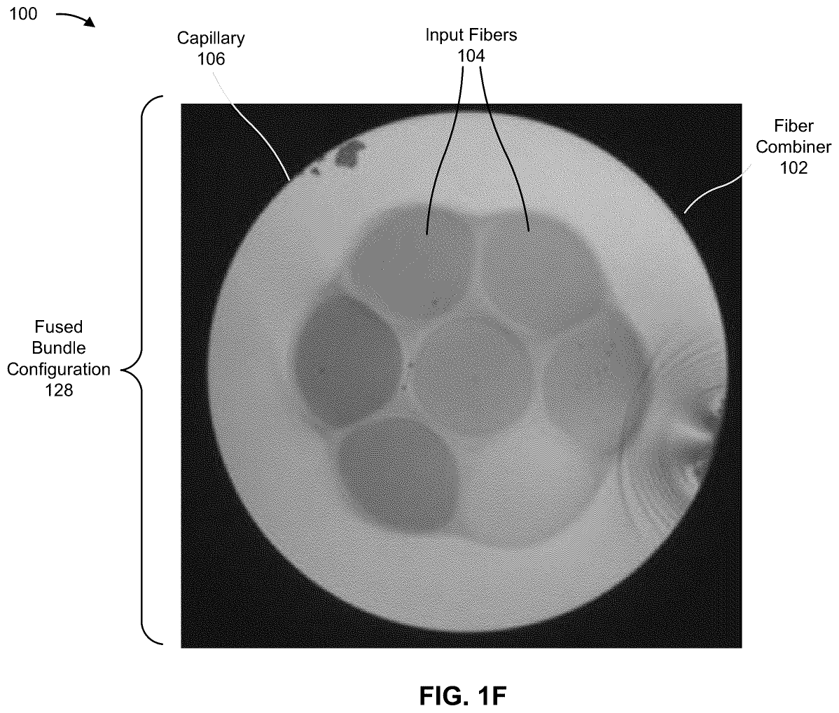

FIGS. 1A-1F are diagrams of an example implementation 100 described herein. As shown in FIGS. 1A-1F, the example implementation 100 may include a fiber combiner 102. The fiber combiner 102 may include a plurality of input fibers 104 and a capillary 106.

Each of the plurality of input fibers 104 may include a fiber cladding and/or a fiber core. For example, an input fiber 104 may include a fiber core that is circumferentially surrounded by a fiber cladding. The plurality of input fibers 104 may be configured to propagate (e.g., via respective fiber cores of the plurality of input fibers 104) input light, such that the input light is to combine to form a combined light beam (e.g., within the fiber combiner 102). For example, portions of the input light may be respectively emitted by a plurality of light sources (e.g., a plurality of laser light sources, not shown) and may respectively propagate via the plurality of input fibers 104 to combine to form the combined light beam. Accordingly, a power (e.g., an optical power) of the combined light beam may be greater than a power of a single portion of the input light that is propagated by a particular input fiber 104 of the plurality of input fibers 104.

In some implementations, the combined light beam may emit from an output end 108 (shown in the longitudinal cross section of FIGS. 1A-1B) of the fiber combiner 102, and may propagate to an output fiber of an output component (not shown). In some implementations, the output end 108 of the fiber combiner 102 may be connected (e.g., spliced) to the output fiber of the output component, such as when the fiber combiner 102 is included in a laser system (e.g., with the output component).

The capillary 106 may be a hollow, open-ended tube (e.g., a cylindrical tube), such as a capillary tube (e.g., a glass capillary tube). Accordingly, an internal portion of the capillary 106 may be defined by a space within the capillary 106, such as a space between internal surfaces of one or more walls of the capillary 106. In some implementations, the plurality of input fibers 104 may be disposed within the capillary 106, such as within the internal portion of the capillary 106.

In some implementations, the plurality of input fibers 104 and the capillary 106 may each comprise glass (e.g., a silica-based glass, a quartz-based glass, a fluorinated glass, and/or another type of glass). In some implementations, the plurality of input fibers 104 and the capillary 106 may comprise a same type of glass. In some implementations, the capillary 106 may comprise a glass that is different than the glass of the plurality of input fibers 104.

As shown in the longitudinal cross section of FIGS. 1A and 1B, the output end 108 of the fiber combiner 102 may include one or more portions, such as a first portion 110, a second portion 112, a third portion 114, and/or a fourth portion 116. The plurality of input fibers 104 and the capillary 106 may each have one or more portions that correspond to at least one of the one or more portions of the output end 108 of the fiber combiner 102. For example, as shown in FIG. 1B, the plurality of input fibers 104 may include a first portion 110F, a second portion 112_{IF}, a third portion 114_{IF}, and/or a fourth portion 116_{IF}, and the capillary 106 may include a first portion 110_{C}, a second portion 112_{C}, and/or a third portion 114_{C}. That is, the first portion 110_{IF} of the plurality of input fibers 104 may be disposed along the first portion 110 of the output end 108 of the fiber combiner 102, the second portion 112_{IF} of the plurality of input fibers 104 may be disposed along the second portion 112 of the output end 108 of the fiber combiner 102, the third portion 114_{IF} of the plurality of input fibers 104 may be disposed along the third portion 114 of the output end 108 of the fiber combiner 102, and/or the fourth portion 116_{IF} of the plurality of input fibers 104 may be disposed along the fourth portion 116 of the output end 108 of the fiber combiner 102. Moreover, the first portion 110_{C} of the capillary 106 may be disposed along the first portion 110 of the output end 108 of the fiber combiner 102, the second portion 112_{C} of the capillary 106 may be disposed along the second portion 112 of the output end 108 of the fiber combiner 102, and/or the third portion 114_{C} of the capillary 106 may be disposed along the third portion 114 of the output end 108 of the fiber combiner 102.

As further shown in FIG. 1B, the first portion 110_{IF} of the plurality of input fibers 104 may be disposed within the first portion 110_{C} of the capillary 106 along the first portion 110 of the output end 108 of the fiber combiner 102, the second portion 112_{IF} of the plurality of input fibers 104 may be disposed within the second portion 112_{C} of the capillary 106 along the second portion 112 of the output end 108 of the fiber combiner 102, and the third portion 114_{IF} of the plurality of input fibers 104 may be disposed within the third portion 114_{C} of the capillary 106 along the third portion 114 of the output end 108 of the fiber combiner 102. Further, the fourth portion 116_{IF} of the plurality of input fibers 104 may be present along the fourth portion 116 of the output end 108 of the fiber combiner 102, and no portion of the capillary 106 may be present along the fourth portion 116 of the output end 108 of the fiber combiner 102. The fourth portion 116_{IF} of the plurality of input fibers 104 may be connected (e.g., spliced) to the output fiber of the output component, such as when the output end 108 of the fiber combiner 102 is connected to the output fiber of the output component.

The first portion 110_{IF} of the plurality of input fibers 104 may be arranged, within the first portion 110_{C} of the capillary 106, in a non-fused bundle configuration (e.g., each of the plurality of input fibers 104 may be separate and distinct from each other within the first portion 110_{C} of the capillary 106). For example, FIG. 1C shows a cross-section of the first portion 110F of the plurality of input fibers 104 arranged in a first non-fused bundle configuration 118 (e.g., when the fiber combiner 102 is a pump combiner and the plurality of input fibers 104 are pump fibers), and FIG. 1D shows a cross-section of the first portion 110_{IF} of the plurality of input fibers 104 arranged in a second non-fused bundle configuration 120 (e.g., when the fiber combiner 102 is a pump-signal combiner and at least one of the plurality of input fibers is a signal fiber 122). The second portion 112_{IF} of the plurality of input fibers 104 may be arranged, within the second portion 112_{C} of the capillary 106, in a partially fused bundle configuration (e.g., the fiber claddings of the plurality of input fibers 104 may be joined together within the second portion 112_{C} of the capillary 106, such as to form a unified bundle of input fibers 104 with one or more gaps between fiber claddings of the plurality of input fibers 104). For example, FIG. 1E shows a cross-section at one longitudinal point of the second portion 112_{IF} of the plurality of input fibers 104 arranged in a partially fused bundle configuration 124 (e.g., when the fiber combiner 102 is a pump combiner and the plurality of input fibers 104 are pump fibers, wherein one or more gaps 126 are formed between fiber claddings of the plurality of input fibers 104). Within second portion 112_{IF}, the input fibers 104 taper along the length of the second portion 112, from a non-fused bundle configuration (as shown, for example in FIGS. 1C) to a partially fused bundle with the input fibers 104 becoming more closely fused and the gaps 126 becoming smaller (as shown in FIG. 1E) to a fully fused unified bundle (as shown in FIG. 1F). The third portion 114_{IF} of the plurality of input fibers 104 may be arranged, within the third portion 114_{C} of the capillary 106, in a fused bundle configuration (e.g., the fiber claddings of the plurality of input fibers 104 may be joined together within the third portion 114_{C} of the capillary 106, such as to form a unified bundle of input fibers 104 without gaps between fiber claddings of the plurality of input fibers 104). For example, FIG. 1F shows a cross-section of the third portion 114_{IF} of the plurality of input fibers 104 arranged in a fused bundle configuration 128 (e.g., when the fiber combiner 102 is a pump combiner and the plurality of input fibers 104 are pump fibers). Additionally, the fourth portion 116_{IF} of the plurality of input fibers 104 may be arranged in a fused bundle configuration (e.g., the fiber claddings of the plurality of input fibers 104 may be joined together along the fourth portion 116 of the output end 108 of the fiber combiner 102, such as to form a unified bundle of input fibers 104 without gaps between fiber claddings of the plurality of input fibers 104), similar to the fused bundle configuration shown in FIG. 1F (e.g., without the capillary 106 shown in FIG. 1F).

In some implementations, the capillary 106 may have one or more slope profiles along the output end 108 of the fiber combiner 102. A slope profile may indicate an angle, with respect to a longitudinal axis 130 of the capillary 106, of an external surface of the one or more walls of the capillary 106 along the output end 108 of the fiber combiner 102. In some implementations, the first portion 110_{C} of the capillary 106 may have a first slope profile along the first portion 110 of the output end 108 of the fiber combiner 102, such as a first zero slope profile shown in FIG. 1B (e.g., an external surface of the one or more walls of the first portion 110_{C} of the capillary 106 is parallel to the longitudinal axis 130 of the capillary 106, within a tolerance, which may be less than or equal to 1 degree, 2 degrees, and/or 3 degrees). In some implementations, the second portion 112_{C} of the capillary 106 may have a second slope profile along the second portion 112 of the output end 108 of the fiber combiner 102, such as a first non-zero slope profile shown in FIG. 1B (e.g., an external surface of the one or more walls of the second portion 112_{C} of the capillary 106 may be at a first angle with respect to the longitudinal axis 130 of the capillary 106, within the tolerance). In some implementations, the third portion 114_{C} of the capillary 106 may have a third slope profile along the third portion 114 of the output end 108 of the fiber combiner 102, such as a second non-zero slope profile shown in FIG. 1B (e.g., an external surface of the one or more walls of the third portion 114_{C} of the capillary 106 may be at a second angle with respect to the longitudinal axis 130 of the capillary 106, within the tolerance).

The first slope profile, the second slope profile, and the third slope profile of the capillary 106 may be different from each other. For example, the first angle and the second angle each may not be zero, and the first angle and the second angle may not be equal to each other. In some implementations, at least one slope profile of the first slope profile, the second slope profile, or the third slope profile may be an adiabatic slope profile. For example, at least a threshold percentage of the combined light beam that propagates through a corresponding portion of the output end 108 of the fiber combiner 102 that is associated with the at least one slope profile does not leak from the corresponding portion of the output end 108 of the fiber combiner 102. The threshold percentage may be greater than or equal to, for example, 95%, 97%, 99%, and/or 99.5%. In some implementations, the second slope profile may be an adiabatic slope profile and/or the third slope profile may be an adiabatic slope profile.

In some implementations, the plurality of input fibers 104 may have one or more slope profiles along the output end 108 of the fiber combiner 102. In some implementations, the first portion 110F of the plurality of input fibers 104 may have a first slope profile along the first portion 110 of the output end 108 of the fiber combiner 102, such as a first zero slope profile shown in FIG. 1B (e.g., an external surface of the non-fused bundle configuration of the first portion 110F of the plurality of input fibers 104 may be parallel to the longitudinal axis 130 of the capillary 106, within the tolerance). In some implementations, the second portion 112_{IF} of the plurality of input fibers 104 may have a second slope profile along the second portion 112 of the output end 108 of the fiber combiner 102, such as a non-zero slope profile shown in FIG. 1B (e.g., an external surface of the partially fused bundle configuration of the second portion 112_{IF} of the plurality of input fibers 104 may be at an angle with respect to the longitudinal axis 130 of the capillary 106, within the tolerance). In some implementations, the third portion 114F of the plurality of input fibers 104 may have a third slope profile along the third portion 114 of the output end 108 of the fiber combiner 102, such as a second non-zero slope profile shown in FIG. 1B (e.g., an external surface of the fused bundle configuration of the third portion 114F of the plurality of input fibers 104 may be at an angle with respect to the longitudinal axis 130 of the capillary 106, within the tolerance). In some implementations, the fourth portion 116_{IF} of the plurality of input fibers 104 may have a fourth slope profile along the fourth portion 116 of the output end 108 of the fiber combiner 102, such as a second zero slope profile shown in FIG. 1B (e.g., an external surface of the fused bundle configuration of the fourth portion 116_{IF} of the plurality of input fibers 104 may be parallel to the longitudinal axis 130 of the capillary 106, within the tolerance) or alternatively, the fourth portion 116 may have another non-zero slope profile (e.g., an external surface of the fused bundle configuration of the fourth portion 116F of the plurality of input fibers 104 may be at another non-zero angle with respect to the longitudinal axis 130 of the capillary 106, within the tolerance). At least two of the first slope profile, the second slope profile, the third slope profile, and the fourth slope profile may be different from each other. For example, the angle and the other angle each may not be zero, and the angle and the other angle may not be equal to each other.

FIGS. 1A-1F are provided as an example. Other examples may differ from what is described with regard to FIGS. 1A-1F.

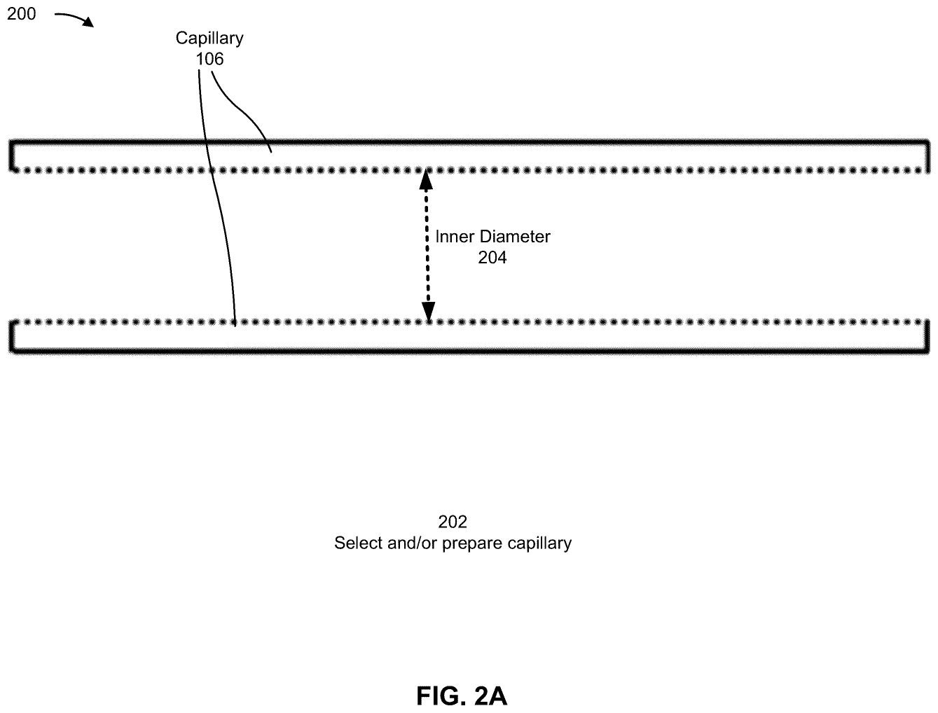

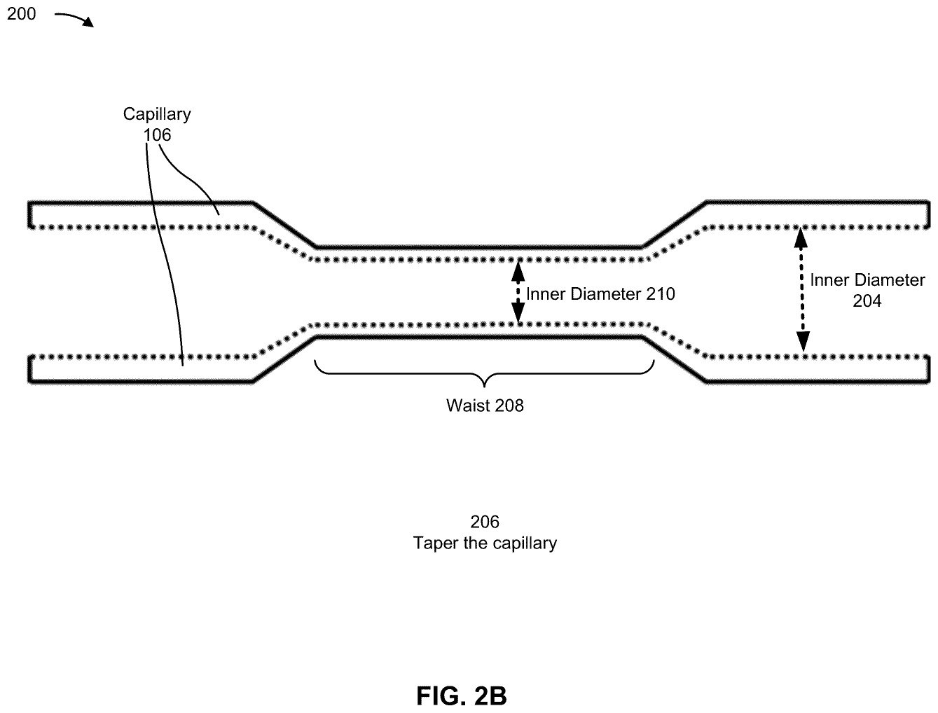

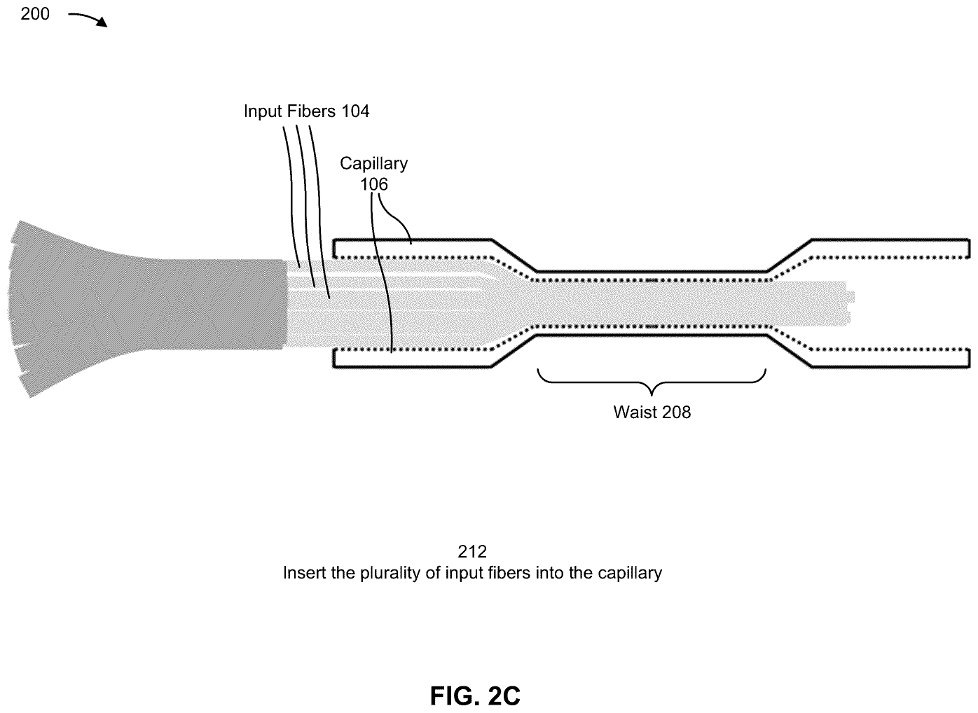

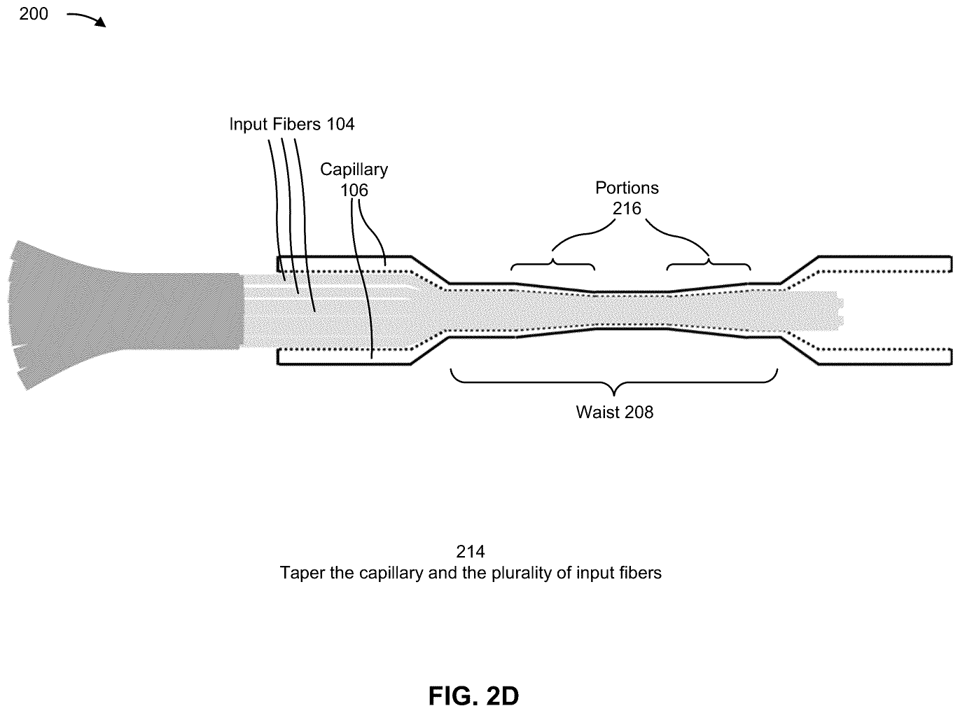

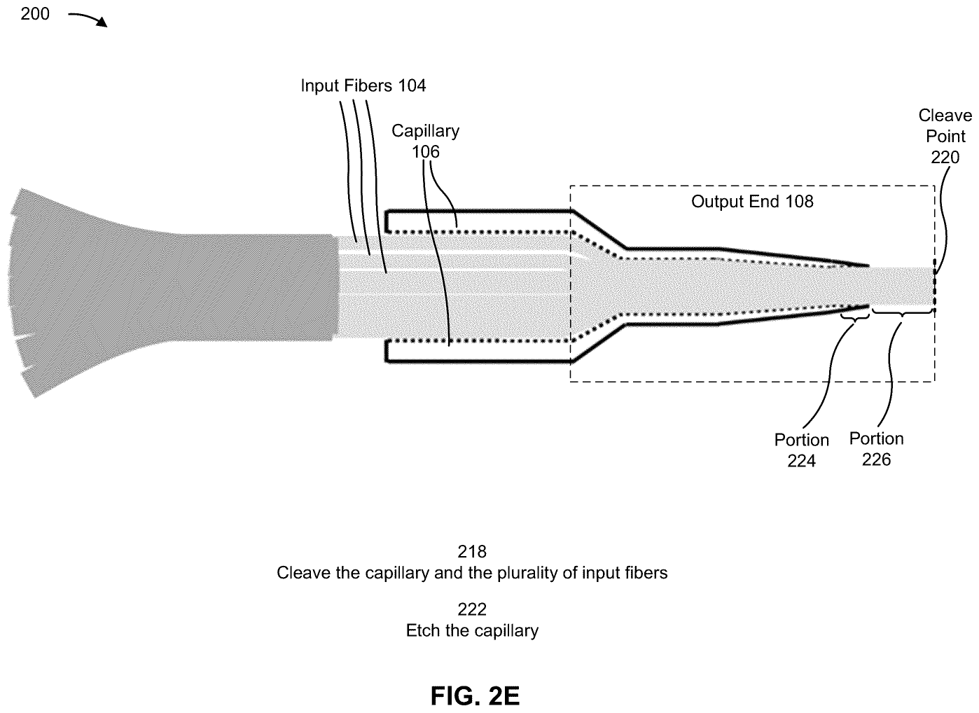

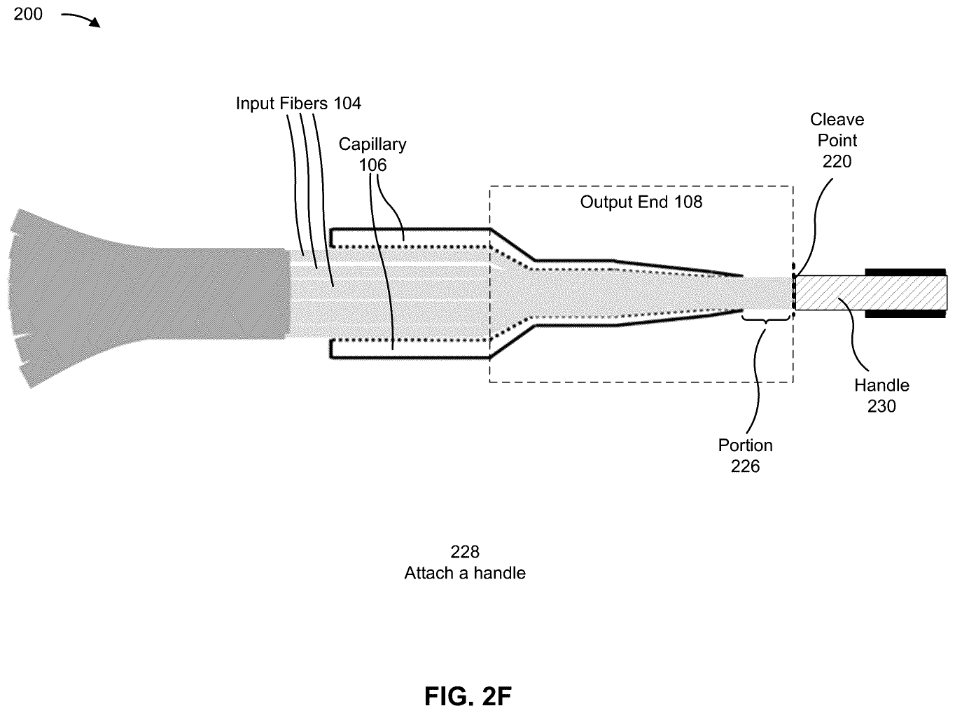

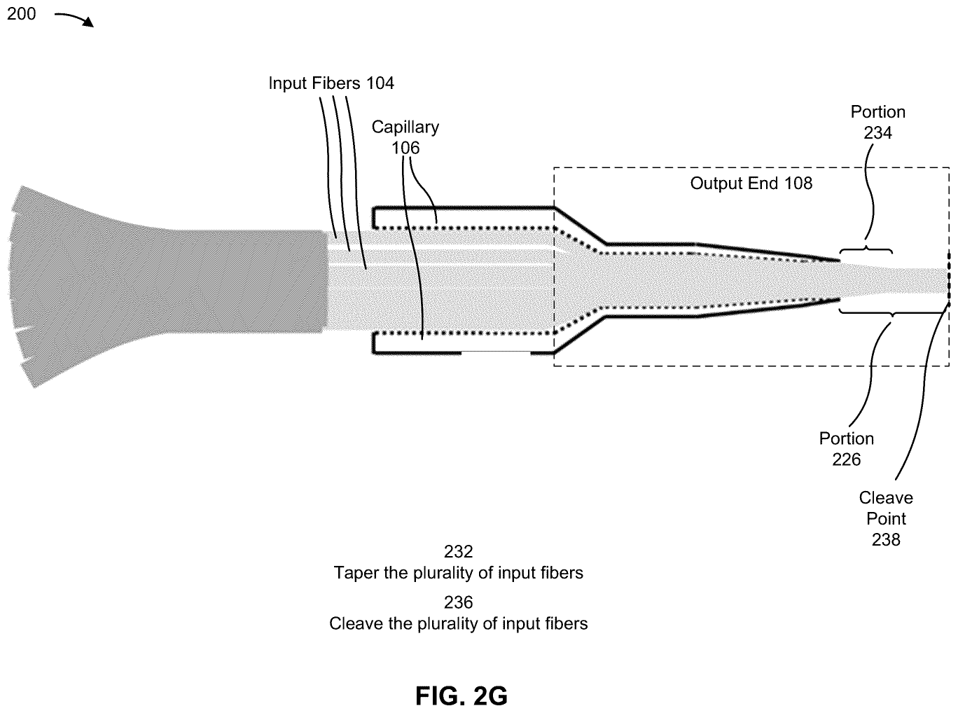

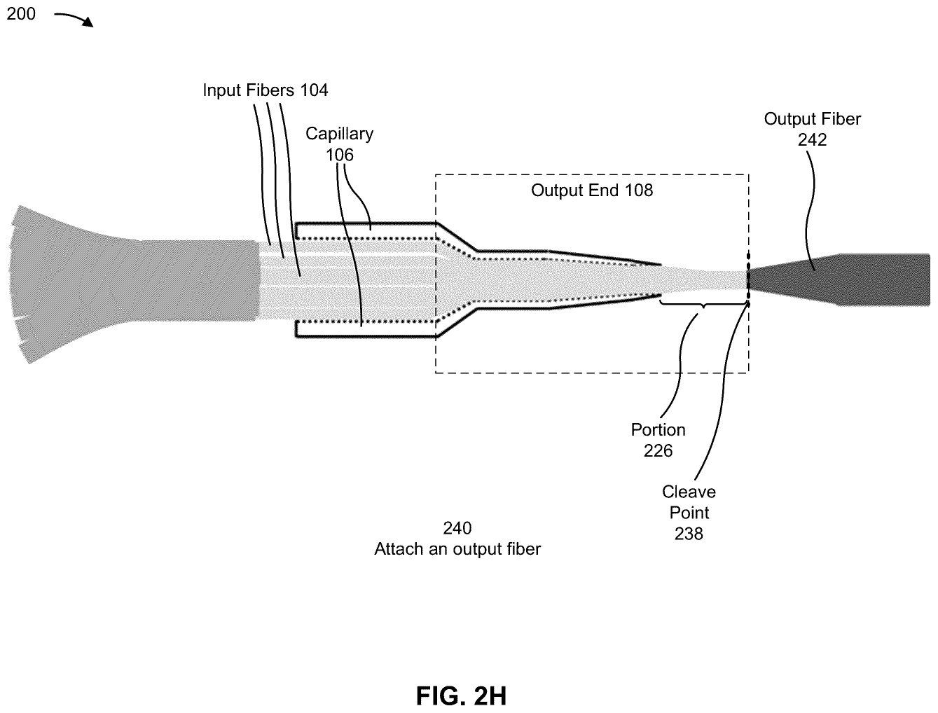

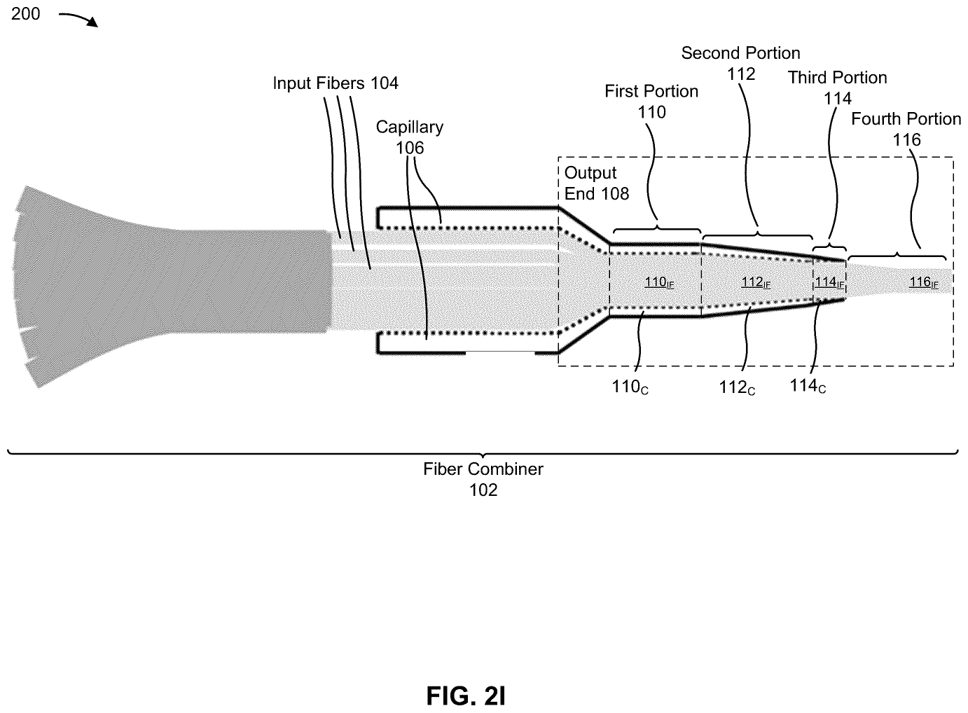

FIGS. 2A-2I are diagrams of an example implementation 200 of a process for forming a fiber combiner, such as the fiber combiner 102 described herein in relation to FIGS. 1A-1F. As shown in FIGS. 2A-2I, the process may include one or more steps.

As shown in the longitudinal cross-section of a capillary of FIG. 2A, and by reference number 202, the process may include selecting and/or preparing a capillary 106. For example, the process may include selecting and/or preparing a capillary 106 with a particular size (e.g., a particular inner diameter and/or a particular outer diameter) such that a plurality of input fibers 104 are able to be inserted into an internal portion of the capillary 106 (e.g., when the plurality of input fibers 104 are arranged in a non-fused bundle configuration, such as shown in FIG. 1C). For example, the process may include selecting and/or preparing a capillary 106 with an inner diameter 204 that is greater than an outer diameter of the plurality of input fibers 104 arranged in the non-fused bundle configuration.

As shown in FIG. 2B, and by reference number 206, the process may include tapering the capillary 106. For example, the process may include applying heat and/or applying a force (e.g., a tensile force) to one or more portions of the capillary 106. In some implementations, tapering the capillary 106 causes the capillary to have a waist 208. The waist 208 may have an inner diameter 210 that is less than the inner diameter 204 (e.g., of one or more portions of the capillary 106 that are not tapered) and that is greater than the outer diameter of the plurality of input fibers 104 arranged in the non-fused bundle configuration (e.g., that are to be inserted into the capillary 106, as described herein). In this way, the waist 208 of the capillary 106 may be formed to hold the plurality of input fibers 104 (e.g., arranged in the non-fused bundle configuration).

As shown in FIG. 2C, and by reference number 212, the process may include inserting the plurality of input fibers 104 into the capillary 106. For example, the process may include inserting the plurality of input fibers 104 into the capillary 106 such that the plurality of input fibers 104 are inserted into the waist 208 of the capillary 106. In this way, the plurality of input fibers 104 may be disposed within the capillary 106 and the waist 208 of the capillary 106. Additionally, the plurality of input fibers 104 may be arranged in the non-fused bundle configuration when disposed within the capillary 106 and the waist 208 of the capillary 106.

As shown in FIG. 2D, and by reference number 214, the process may include tapering the capillary 106 and the plurality of input fibers 104. For example, the process may include applying heat and/or applying a force (e.g., a tensile force) to one or more portions of the capillary 106, within which the plurality of input fibers 104 are disposed. In a particular example, as shown in FIG. 2D, the process may include tapering one or more portions 216 of the waist 208 of the capillary 106, and one or more corresponding portions of the plurality of input fibers 104 that are disposed within the one or more portions 216 of the waist 208 of the capillary 106. In some implementations, as a result of the tapering, the one or more portions 216 of the waist and the one or more corresponding portions of the plurality of input fibers 104 may fuse to form a partially fused bundle arrangement (e.g., similar to that shown in FIG. 1E) or a fused bundle arrangement (e.g., similar to that shown in FIG. 1F). In some implementations, as a result of the tapering, the one or more portions 216 of the waist 208 of the capillary 106 may each have a first non-zero slope profile (e.g., as described elsewhere herein). The first non-zero slope profile may be an adiabatic slope profile.

As shown in FIG. 2E, and by reference number 218, the process may include cleaving the capillary 106 and the plurality of input fibers 104 (e.g., at a particular point). For example, the process may include cleaving the capillary 106 and the plurality of input fibers 104 at a cleave point 220 along the waist 208 of the capillary 106. In this way, an output end 108 (e.g., of the fiber combiner 102) may be formed.

As further shown in FIG. 2E, and by reference number 222, the process may include etching the capillary 106 (e.g., using one or more etching techniques, such as a wet etching technique, a reactive ion etching technique and/or another etching technique). In some implementations, etching the capillary 106 may include etching a portion 224 of the capillary 106 (e.g., that is a sub-portion of a portion of the one or more portions 216 of the waist 208 of the capillary 106) and etching another portion of the capillary 106 (e.g., that is adjacent to the portion 224 along the waist 208 of the capillary 106). In some implementations, etching the portion 224 may cause the portion 224 to have a second non-zero slope profile (e.g., as described elsewhere herein). The second non-zero slope profile may be an adiabatic slope profile. In some implementations, etching the other portion of the waist 208 of the capillary 106 may cause the other portion to be removed (e.g., to be etched away). Notably, etching the other portion may not affect a portion 226 of the plurality of input fibers 104 (e.g., may not etch the portion 226 of the plurality of input fibers 104) that were disposed within the other portion of the waist 208 of the capillary 106 (e.g., prior to removal of the other portion by etching).

As shown in FIG. 2F, and by reference number 228, the process may include attaching a handle 230 to the output end 108 (e.g., of the fiber combiner 102). For example, the process may include splicing the portion 226 of the plurality of input fibers 104 (e.g., at the cleave point 220) to the handle 230. The handle 230 may include one or more fibers (e.g., that are similar to the plurality of input fibers 104). Alternatively, the handle 230 may include a single large diameter fiber.

As shown in FIG. 2G, and by reference number 232, the process may include tapering the plurality of input fibers 104. For example, the process may include applying heat and/or applying a force (e.g., a tensile force, such as via pulling on the handle 230) to one or more portions of the plurality of input fibers 104. In a particular example, as shown in FIG. 2G, the process may include tapering a portion 234 (e.g., that is a sub-portion of the portion 226 of the plurality of input fibers 104). In some implementations, as a result of the tapering, the portion 234 of the plurality of input fibers 104 may have a third non-zero slope profile (e.g., as described elsewhere herein).

As further shown in FIG. 2G, and by reference number 236, the process may include cleaving the plurality of input fibers 104 (e.g., at a particular point). For example, the process may include cleaving the plurality of input fibers 104 at a cleave point 238 along the portion 226 of the plurality of input fibers 104.

As shown in FIG. 2H, and by reference number 240, the process may include attaching an output fiber 242 (e.g., of an output component, not shown) to the output end 108 (e.g., of the fiber combiner 102). For example, the process may include splicing the portion 226 of the plurality of input fibers 104 (e.g., at the cleave point 238) to the output fiber 242. The output fiber 242 may include one or more fibers.

FIG. 2I shows a fiber combiner 102 formed as a result of performing one or more steps related to the process described herein (e.g., in relation to FIGS. 2A-2H). Accordingly, as further shown in FIG. 2I, the output end 108 of the fiber combiner 102 may include one or more portions, such as a first portion 110, a second portion 112, a third portion 114, and/or a fourth portion 116, which are described elsewhere herein in relation to FIGS. 1A-1F. Moreover, the plurality of input fibers 104 may include a first portion 110_{IF}, a second portion 112_{IF}, a third portion 114_{IF}, and/or a fourth portion 116_{IF}(e.g., that corresponds to the portion 226 of the plurality of input fibers 104), and the capillary 106 may include a first portion 110_{C}, a second portion 112_{C} (e.g., that corresponds to a portion of the one or more portions 216 of the waist 208 of the capillary 106), and/or a third portion 114_{C} (e.g., that corresponds to the portion 224 of the capillary 106), which are described elsewhere herein in relation to FIGS. 1A-1F.

FIGS. 2A-2I are provided as an example. Other examples may differ from what is described with regard to FIGS. 2A-2I.

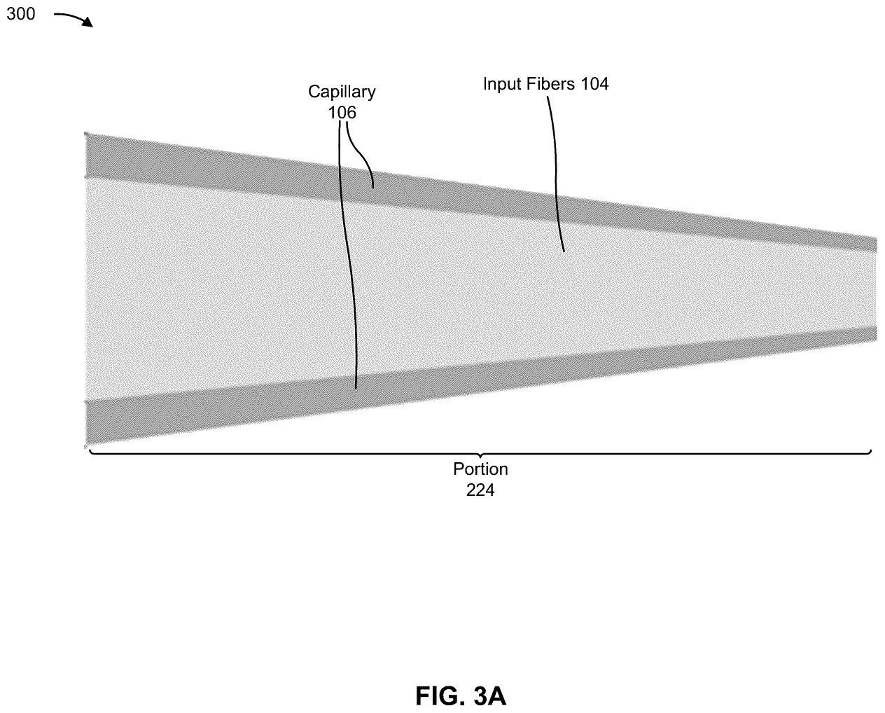

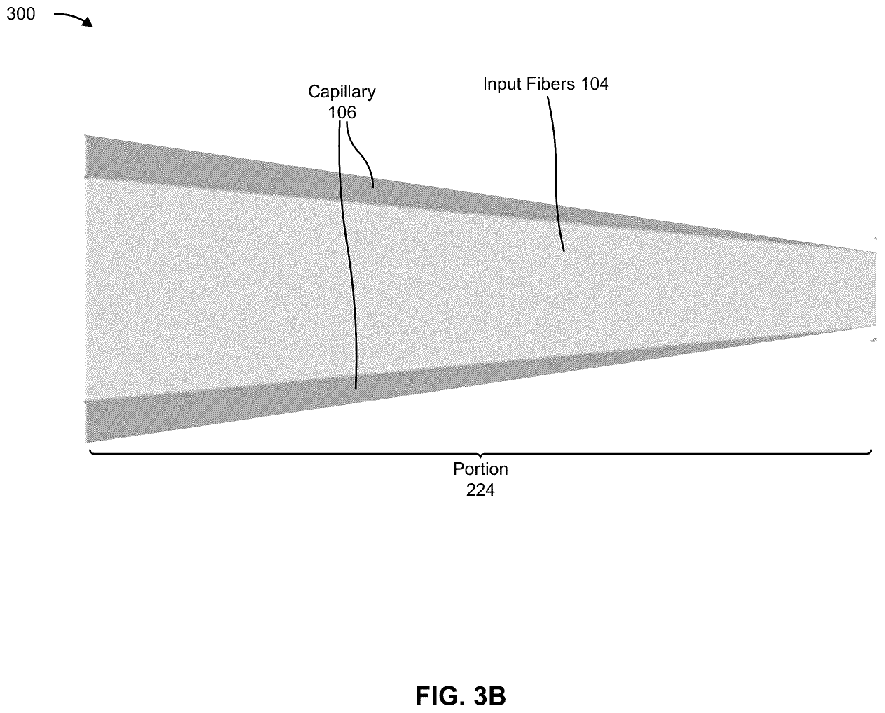

FIGS. 3A-3B are diagrams of an example implementation 300 associated with the portion 224 of the capillary 106.

In some implementations, one or more of the steps of the process described herein in relation to FIGS. 2A-2I may be modified, omitted, and/or performed in a different order than that described herein in relation to FIGS. 2A-2I. For example, the process may include tapering the capillary 106 and the plurality of input fibers 104 (e.g., as described herein in relation to FIG. 2D and reference number 214), but may not include attaching the handle 230 (e.g., as described herein in relation to FIG. 2F and reference number 228) and tapering the plurality of input fibers 104 (e.g., as described herein in relation to FIG. 2G and reference number 232). As another example, the process may include tapering the capillary 106 and the plurality of input fibers 104, such that the plurality of input fibers 104 is sized to be attached to the output fiber 242 (e.g., described herein in relation to FIG. 2H and reference number 240). FIG. 3A shows the portion 224 of the capillary 106 after tapering the capillary 106 and the plurality of input fibers 104 in this way. The process then may include etching the capillary 106 and then cleaving the capillary 106 and the plurality of input fibers 104, instead of the reverse order described herein in relation FIG. 2E and reference numbers 218 and 222. FIG. 3B shows the portion 224 of the capillary 106 after etching the capillary 106 in this way.

FIGS. 3A-3B are provided as an example. Other examples may differ from what is described with regard to FIGS. 3A-3B.

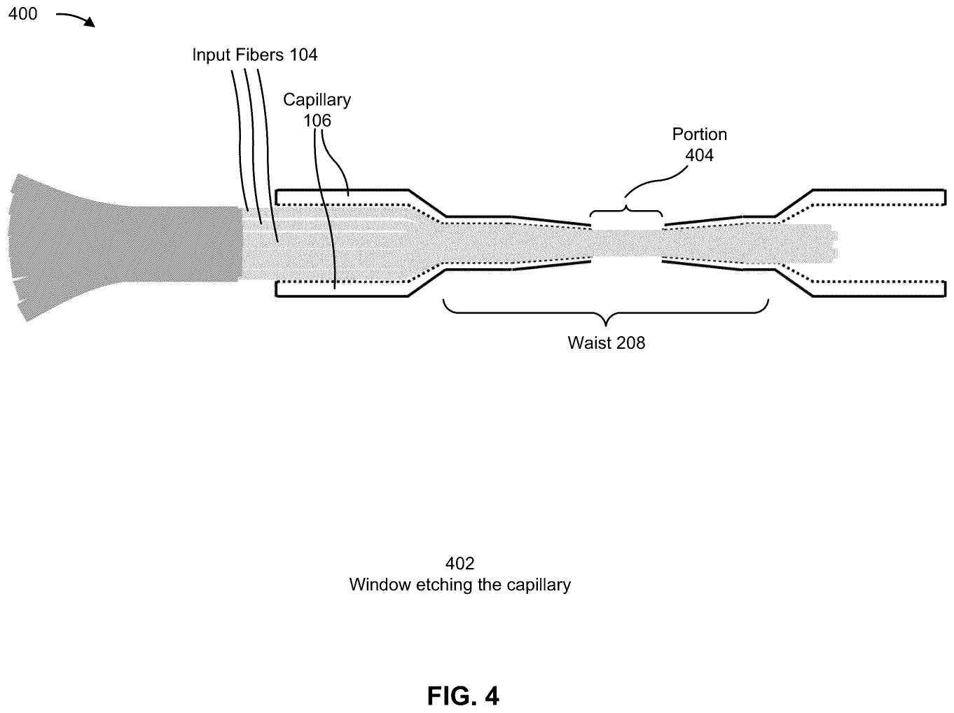

FIG. 4 is a diagram of an example implementation 400 associated with the process for forming the fiber combiner (e.g., as described herein in relation to FIGS. 2A-2I). As shown in FIG. 4, and by reference number 402, as an alternative to cleaving the capillary 106 and the plurality of input fibers 104 (e.g., as described herein in relation to FIG. 2E and reference number 218), etching the capillary 106 (e.g., as described herein in relation to FIG. 2E and reference number 222), and attaching the handle 230 (e.g., as described herein in relation to FIG. 2F and reference number 228), the process may include window etching the capillary 106. In some implementations, window etching the capillary 106 may include etching a portion of the waist 208 of the capillary 106 to cause the portion to be removed (e.g., to be etched away). Notably, etching the other portion may not affect a portion 404 of the plurality of input fibers 104 (e.g., may not etch the portion 404 of the plurality of input fibers 104) that were disposed within the portion of the waist 208 of the capillary 106 (e.g., prior to removal of the portion by window etching). Further, respective portions of the capillary 106 and the plurality of input fibers 104 remain that would have otherwise been removed due to cleaving the capillary 106 and the plurality of input fibers 104 (e.g., as described herein in relation to FIG. 2E and reference number 218). The respective portions of the capillary 106 and the plurality of input fibers 104 therefore may be used in lieu of the handle 230 to facilitate tapering the plurality of input fibers 104 (e.g., as described herein in relation to FIG. 2G and reference number 232).

Some implementations described herein use one or more other techniques, such as a laser ablation technique, a mechanical machining technique, and/or another technique, as an alternative to etching.

FIG. 4 is provided as an example. Other examples may differ from what is described with regard to FIG. 4.

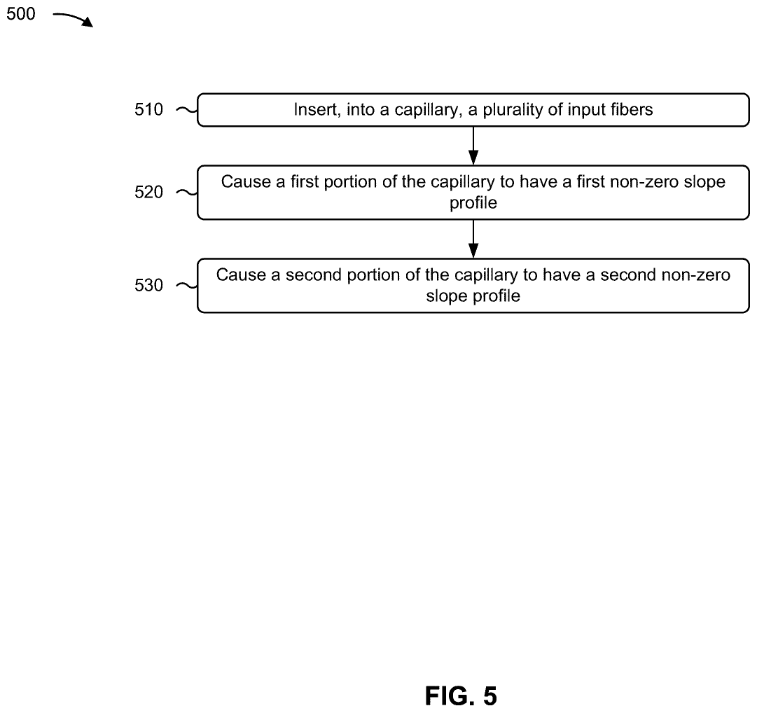

FIG. 5 is a flowchart of an example process 500 associated with forming a fiber combiner with a capillary. In some implementations, one or more process blocks of FIG. 5 are performed by a system configured to form the fiber combiner.

As shown in FIG. 5, process 500 may include inserting, into a capillary, a plurality of input fibers (block 510). For example, the system may insert, into a capillary, a plurality of input fibers, as described above.

As further shown in FIG. 5, process 500 may include causing a first portion of the capillary to have a first non-zero slope profile (block 520). For example, the system may cause a first portion of the capillary to have a first non-zero slope profile, as described above.

As further shown in FIG. 5, process 500 may include causing a second portion of the capillary to have a second non-zero slope profile (block 530). For example, the system may cause a second portion of the capillary to have a second non-zero slope profile, as described above.

Process 500 may include additional implementations, such as any single implementation or any combination of implementations described below and/or in connection with one or more other processes described elsewhere herein.

In a first implementation, causing the first portion of the capillary to have the first non-zero slope profile comprises tapering the first portion of the capillary, wherein tapering the first portion of the capillary also tapers a portion of the plurality of input fibers disposed within the first portion of the capillary.

In a second implementation, alone or in combination with the first implementation, causing the second portion of the capillary to have the second non-zero slope profile comprises etching the second portion of the capillary, wherein etching the second portion of the capillary does not affect a portion of the plurality of input fibers disposed within the second portion of the capillary.

In a third implementation, alone or in combination with one or more of the first and second implementations, causing the second portion of the capillary to have the second non-zero slope profile causes a third portion of the capillary to be removed, wherein causing the third portion of the capillary to be removed does not affect a portion of the plurality of input fibers disposed within the third portion of the capillary.

In a fourth implementation, alone or in combination with one or more of the first through third implementations, causing the second portion of the capillary to have the second non-zero slope profile comprises cleaving the capillary, and the plurality of input fibers within the capillary, at a particular point to form an output end of the fiber combiner, wherein the output end of the fiber combiner includes the first portion of the capillary, the second portion of the capillary, and a third portion of the capillary; and etching, based on cleaving the capillary, the second portion of the capillary and the third portion of the capillary, wherein etching the second portion of the capillary causes the second portion of the capillary to have the second non-zero slope profile, and wherein etching the third portion of the capillary causes the third portion of the capillary to be removed.

In a fifth implementation, alone or in combination with one or more of the first through fourth implementations, causing the second portion of the capillary to have the second non-zero slope profile comprises etching the second portion of the capillary and a third portion of the capillary, wherein etching the second portion of the capillary causes the second portion of the capillary to have the second non-zero slope profile, and wherein etching the third portion of the capillary causes the third portion of the capillary to be removed and thereby causes a portion of the plurality of input fibers to be exposed that was previously disposed within the third portion of the capillary; and cleaving, based on etching the second portion of the capillary and the third portion of the capillary, the plurality of input fibers at a particular point associated with the portion of the plurality of input fibers to form an output end of the fiber combiner.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A fiber combiner comprising:
a capillary; and
a plurality of input fibers, wherein:
a first portion of the plurality of input fibers is disposed within a first portion of the capillary along a first portion of an output end of the fiber combiner;
the first portion of the capillary has a zero slope profile along the first portion of the output end of the fiber combiner;
a second portion of the plurality of input fibers is disposed within a second portion of the capillary along a second portion of the output end of the fiber combiner;
the second portion of the capillary has a first non-zero slope profile along the second portion of the output end of the fiber combiner;
a third portion of the plurality of input fibers is disposed within a third portion of the capillary along a third portion of the output end of the fiber combiner;
the third portion of the capillary has a second non-zero slope profile along the third portion of the output end of the fiber combiner,
wherein the second non-zero slope profile is different than the first non-zero slope profile;
a fourth portion of the plurality of input fibers is present along a fourth portion of the output end of the fiber combiner; and
no portion of the capillary is present along the fourth portion of the output end of the fiber combiner.

2. The fiber combiner of claim 1, wherein the third portion of the plurality of input fibers and the fourth portion of the plurality of input fibers are each arranged in a fused bundle configuration.

3. The fiber combiner of claim 1, wherein the second non-zero slope profile is an adiabatic slope profile.

4. The fiber combiner of claim 1, wherein the fiber combiner is a pump combiner, and the plurality of input fibers are pump fibers.

5. The fiber combiner of claim 1, wherein the fiber combiner is a pump-signal combiner, and at least one of the plurality of input fibers is a signal fiber.

6. The fiber combiner of claim 1, wherein the fourth portion of the plurality of input fibers has another zero slope profile along the fourth portion of the output end of the fiber combiner.

7. The fiber combiner of claim 1, wherein the fourth portion of the plurality of input fibers has a third non-zero slope profile along the fourth portion of the output end of the fiber combiner.

8. The fiber combiner of claim 1, wherein the fourth portion of the plurality of input fibers is connected to an output fiber of an output component.

9. A fiber combiner comprising:
a capillary; and
a plurality of input fibers disposed within the capillary, wherein:
a first portion of the capillary has a first non-zero slope profile along a first portion of an output end of the fiber combiner; and
a second portion of the capillary has a second non-zero slope profile along a second portion of the output end of the fiber combiner,
wherein the second non-zero slope profile is different than the first non-zero slope profile.

10. The fiber combiner of claim 9, wherein no portion of the capillary is present along a third portion of the output end of the fiber combiner.

11. The fiber combiner of claim 9, wherein:
a first portion of the plurality of input fibers is disposed within the first portion of the capillary along the first portion of the output end of the fiber combiner;
a second portion of the plurality of input fibers is disposed within the second portion of the capillary along the second portion of the output end of the fiber combiner;
a third portion of the plurality of input fibers is present along a third portion of the output end of the fiber combiner; and
no portion of the capillary is present along the third portion of the output end of the fiber combiner.

12. The fiber combiner of claim 11, wherein the second portion of the plurality of input fibers and the third portion of the plurality of input fibers are each arranged in a fused bundle configuration.

13. The fiber combiner of claim 9, wherein the second non-zero slope profile is an adiabatic slope profile.

14. The fiber combiner of claim 9, wherein the first non-zero slope profile is an adiabatic slope profile.

15. A method for forming a fiber combiner, comprising:
inserting, into a capillary, a plurality of input fibers;
causing a first portion of the capillary to have a first non-zero slope profile; and
causing a second portion of the capillary to have a second non-zero slope profile.

16. The method of claim 15, wherein causing the first portion of the capillary to have the first non-zero slope profile comprises:
tapering the first portion of the capillary,
wherein tapering the first portion of the capillary also tapers a portion of the plurality of input fibers disposed within the first portion of the capillary.

17. The method of claim 15, wherein causing the second portion of the capillary to have the second non-zero slope profile comprises:
etching the second portion of the capillary,
wherein etching the second portion of the capillary does not affect a portion of the plurality of input fibers disposed within the second portion of the capillary.

18. The method of claim 15, wherein causing the second portion of the capillary to have the second non-zero slope profile causes a third portion of the capillary to be removed,
wherein causing the third portion of the capillary to be removed does not affect a portion of the plurality of input fibers disposed within the third portion of the capillary.

19. The method of claim 15, wherein causing the second portion of the capillary to have the second non-zero slope profile comprises:
cleaving the capillary, and the plurality of input fibers within the capillary, at a particular point to form an output end of the fiber combiner,
wherein the output end of the fiber combiner includes the first portion of the capillary, the second portion of the capillary, and a third portion of the capillary; and
etching, based on cleaving the capillary, the second portion of the capillary and the third portion of the capillary,
wherein etching the second portion of the capillary causes the second portion of the capillary to have the second non-zero slope profile, and
wherein etching the third portion of the capillary causes the third portion of the capillary to be removed.

20. The method of claim 15, wherein causing the second portion of the capillary to have the second non-zero slope profile comprises:
etching the second portion of the capillary and a third portion of the capillary,
wherein etching the second portion of the capillary causes the second portion of the capillary to have the second non-zero slope profile, and
wherein etching the third portion of the capillary causes the third portion of the capillary to be removed and thereby causes a portion of the plurality of input fibers to be exposed that was previously disposed within the third portion of the capillary; and
cleaving, based on etching the second portion of the capillary and the third portion of the capillary, the plurality of input fibers at a particular point associated with the portion of the plurality of input fibers to form an output end of the fiber combiner.
